(19) United States
(12) Patent Application Publication
(10) Pub. No.: US 2006/0277249 A1
(43) Pub. Date: Dec. 7, 2006

(54) Robotic web browser

(75) Inventors: Amr Yassin, Chesterfield, MO (US); Yasser AL Safadi, Yorktown Heights, NY (US); Octav Chipara, Bloomington, IN (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/539,904

(22) PCT Filed: Dec. 3, 2003
(86) PCT No.: PCT/IB03/05619

§ 371 Date: Aug. 14, 2006

Related U.S. Application Data
(60) Provisional application No. 60/433,749, filed on Dec. 16, 2002.

(51) Int. Cl. G06F 15/16

(52) U.S. Cl. 709/203

(57) ABSTRACT

A robotic web browser (120, 122) is disclosed capable of rendering high level program instructions received via an electronic network (150) such as the Internet. Upon rendering the downloaded instructions, the robotic web browser (120, 122) performs three-dimensional movements and plays back video and audio streams.

### 1. FIELD OF THE INVENTION

The present invention relates generally to web browsers, and more particularly to a novel multi-dimensional robotic web browser for rendering data in at least three dimensions.

### 2. DESCRIPTION OF RELATED ART

The Internet is a vast, connected network of heterogeneous computer resources, spanning the globe and growing daily. Currently, Internet usage, and particularly that of the World Wide Web (henceforth referred to as simply the “web”), is growing explosively, particularly as the number of web sites and users that have access to the Internet continue to rapidly and to a great extent, exponentially expand. The web provides for both a friendly graphical interface to Internet resources and a standardized means of presenting and accessing them. One of the major differences between the world wide web and earlier Internet technologies is its highly graphical nature. The most recent innovation in the continuing evolution of the world wide web has been the introduction of the synchronized multimedia integration language, SMIL, which addresses the issue of synchronizing web pages. SMIL is to synchronized multimedia what HTML is to hyperlinked text. SMIL is a simple, vendor-neutral markup language designed to let Web builders of all skill levels schedule audio, video, text, and graphics files across a timeline without having to master development tools or complex programming languages.

From a user's point of view, access to the continuing evolution of the Internet and its services typically are accomplished by invoking a network application program such as a network browser. The browser is perhaps the most important application for retrieving and viewing information from the Internet. The browser acts as an interface between the user and the Internet. The network browser is commonly referred to today as a web browser because of its ability to retrieve and display Web pages from the World Wide Web. Some examples of commercially available browsers include the Internet Explorer™ by Microsoft Corporation of Redmond, Wash., Netscape™ Navigator by Netscape Communications of Mountain View, Calif., and Mosaic developed at NCSA, University of Illinois.

As new standards are developed to make the content of Web pages more compelling, Web browsers have been upgraded to support them. This has made the Web browser the key application for accessing information from the Internet and from networks based on Internet standards.

While the traditional network web browser will continue to serve a vital function, the present invention extends the traditional definition of a ‘browser’. In particular, the present invention discloses the use of robots as higher dimensional web browsers capable of rendering instructions through movement, sights and sounds. Such multi-dimensional rendering capability, to the best of the applicants' knowledge, represent a significant and remarkable advance over what has heretofore been available in the network browser art.

The present invention is directed to a robotic web browser capable of rendering high level program instructions. The robotic web browser is similar to a conventional web browser (e.g., Internet Explorer) in the sense that both the conventional browser and the robotic browser of the invention are configured to receive program instructions from an electronic network such as the Internet. However, the robotic web browser of the invention is distinguishable from a conventional web browser in that at least a portion of the high level program instructions are rendered as three-dimensional robotic movements. By contrast, the conventional browser is constrained to rendering instructions in two-dimensions on a video display.

According to one aspect, the program instructions may be rendered in real time or stored for rendering at a future time.

According to another aspect, the program instructions could be downloaded over the Internet or otherwise provided and stored locally. The robotic browser could include any number of storage media including, but not limited to, CD-ROM, ROM, RAM, hard-drive, or flash memory.

Advantageously, the robotic web browser of the invention is well suited to a myriad of applications, including, but not limited to, selling merchandise in a retail outlet, a robotic newsreader, and for use in puppetry. In each scenario, the robotic web browser executes a set of program instructions through animated movements, sights and sounds. Such capability is attractive to all consumer demographics and especially to children.

In the drawings:

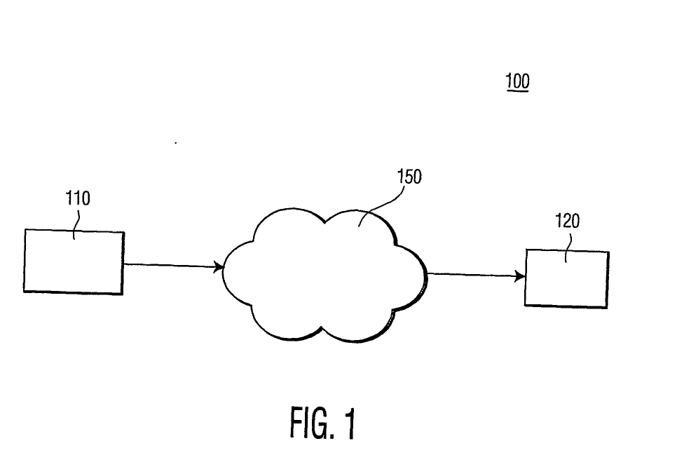

FIG. 1 shows a network implementing an embodiment of the present invention.

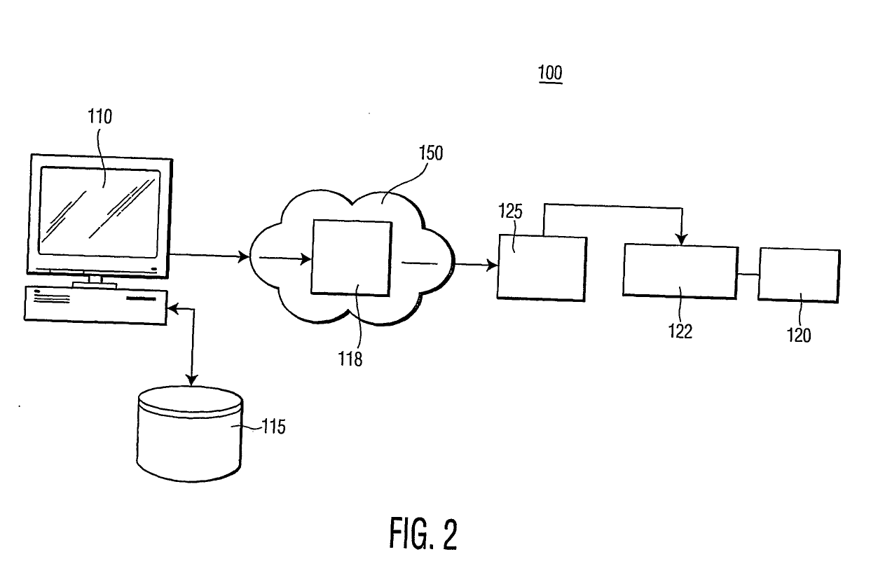

FIG. 2 illustrates the network of FIG. 1 in more detail.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

FIG. 1 is a block diagram of a network 100 implementing an embodiment of the present invention. The network includes a computer system 110 at a first location and a robot 120 at a second location. The computer system 110 and the robot 120 are coupled via an electronic network 150. The computer system 110 can be a personal computer and the robot 120 can be any web-enabled device capable of movement in three dimensions and additionally capable of displaying video and/or audio. The electronic network can be any network such as the Internet, a Wide Area Network (WAN), a local area network (LAN), or any combination thereof.

In a typical application, an end user, typically an artist or advertising person, develops a web based presentation at a remote location in a high level markup language using the first computer system 110. While the specific details of the high level markup language are the subject of a co-pending application, and as such will not be discussed in detail herein, it is instructive to point out that the high level markup language requires no particular programming expertise on behalf of a user wishing to develop a robotic application. Briefly, the web presentation could be developed by grabbing and dropping a sequence of operators which make up the high level markup language. Representative sequence operators might include, for example, directives to cause the robot to:

| | |
|---|---|
| Step 1 | PERFORM A COUNTRY DANCE |
| Step 2 | BLINK TWICE |
| Step 3 | SMILE AT EVERYONE |
| Step 4 | BOW |
| Step 5 | SHAKE EVERYONES HAND |

As shown, the user (i.e., developer) works with simplified, straight forward statements and concepts. Unlike prior art approaches to robotic programming, the esoteric aspects of robotic movement are completely transparent on the applications level.

FIG. 2 is a more detailed illustration of the network 100 of FIG. 1. In FIG. 2 there is shown an XML (extensible markup language) embodiment of the system of the invention. Specifically, FIG. 2 illustrates that the computer system 110 has associated therewith a database 115 for storing robotic presentations (i.e., scenarios), written in a high-level XML markup language by a user of the computer system 110. Subsequent to creating the robotic scenarios, they may be uploaded to an XML server 118 in the Internet. At some future point in time, an XML client 125 at the second location may download one of the robotic scenarios stored on the XML server 118 to be used in a robotic presentation involving robot 120, via the robotic controller 122. It is to be appreciated that, while only one robot 120 is shown for easy explanation, any number of robots, having any number of configurations, may independently access the XML server to download robotic presentations. Furthermore, while only one computer system 110 is shown, in a similar manner, any number of computer systems may independently create robotic presentations to be uploaded to the XML server 118. Therefore, it is shown that the XML server 118, serves as a central repository for receiving robotic presentations or scenarios written in a high-level markup language from a plurality of sources to be made available to a plurality of robots desiring to execute or perform those scenarios. As is well known to those in the art, XML server 118 could represent a single server or a plurality of servers, either co-located or distributed throughout the Internet 150.

Some exemplary uses for the robotic web browser of the invention are described below. It is to be understood, however, that the specific cases are not limiting, rather they are provided as exemplary to facilitate a more complete understanding of the invention.

1st Exemplary Use

A first exemplary application of the present invention is for use as a newsreader.

That is it is contemplated that an electronic edition of a newspaper is prepared at an electronic news preparer's facility. The newspaper facility would embed in the electronic newspaper, sounds, images, and movements for use by the robot 120. The robot 120 could include in its memory customizations that would indicate user preferences regarding how the news is read, at what pace, how loud, and control the gesticulations (i.e., motor movements) of the robot 120. The news information could be transmitted from the newspaper facility over the Internet 150 for presentation by the robot 120 in real-time or for later viewing. Alternatively, the news information could be mailed on a CD-ROM, for example, to the user's home for insertion into the robotic news reader 120.

2^{nd} Exemplary Use

A second exemplary application of the present invention is for use in a puppet show. It is contemplated that children would be a highly receptive audience to robots. Thus, it is envisioned that a series of applications could be developed that would specifically target children.

In one embodiment, it is contemplated that popular television shows, such as those shown on the Cartoon Network or Nickelodeon could be synchronized with movements of the robot 120 thereby enhancing the entertainment value of the broadcast, making it more interactive and entertaining.

In another related embodiment, it is contemplated that puppet shows would include one or more or the robots 120 as puppets, where each puppet produces certain behaviors and interactions based on the story line. The story line would preferably be provided to the robots, either over an electronic network or on a storage medium such as a CD-ROM.

3rd Exemplary Use

A third exemplary application of the present invention is for use in selling items in a store. The robot 120 would be informed, via a download, which items the robot 120 must persuade a consumer to buy. In this case, a manufacturer of orange juice, for example, could either prepare a presentation for use by the robot 120, or more conventionally access any one of a number of pre-stored presentations in the robot 120. It is further contemplated that the pre-stored presentations could be modified to suit the changing needs of the manufacturers. In this manner, development time is minimized. The robot, being web-enabled, could in response to a manufacturer's request over the Internet, access its repository of possible presentations that it can make, and choose the appropriate presentation for selling orange juice, for example.

1. A multi-dimensional robotic web browser (120, 122), comprising:
means for downloading high level program instructions transmitted over an electronic network (150); and
means for rendering said downloaded high level program instructions transmitted over said electronic network (150), such that when at least a portion of said downloaded instructions (115) are rendered, direct said robotic web browser (120, 122) to one of move in three dimensions, play back an audio stream, or play back a video stream.

2. The multi-dimensional robotic web browser (120, 122) of claim 1, further comprising:
means for storing (115, 118) said downloaded high level program instructions;
means for retrieving said downloaded high level program instructions from said storing means (115, 118), such that when at least a portion of said stored instructions are rendered by said robotic web browser (120, 122), direct said robotic web browser (120, 122) to one of move in three-dimensions, playback an audio stream, playback a video stream;

3. The multi-dimensional robotic web browser (120, 122) of claim 1, further comprising:
means for rendering pre-stored high level program instructions pre-stored on one or more computer-readable media coupled to or integrated with said robotic web browser (120, 122), such that when at least a portion of said local high level program instructions are rendered, said robotic web browser (120, 122) is directed to move in three dimensions, play back an audio stream, or play back a video stream.

4. The multi-dimensional robotic web browser (120, 122) of claim 1, wherein said high level program instructions comprise computer-executable code written in a high level markup language.

5. The multi-dimensional robotic web browser (120, 122) of claim 1, further comprising:
means for processing data in two-dimensions in accordance with current and future network browser standards.

6. The multi-dimensional robotic web browser (120, 122) of claim 1, wherein said electronic network is the Internet.

7. The multi-dimensional robotic web browser (120, 122) of claim 6, wherein said program instructions are downloaded in accordance with a recognized Internet transmission protocol.

8. The multi-dimensional robotic web browser (120, 122) of claim 1, wherein said electronic network is one or a wireless or wired network.

9. A system for executing high level language instructions, downloaded over an electronic network (150), said instructions for processing in a multi-dimensional robotic web browser (120, 122), the system comprising:
at least one remote computer (110) for generating said high level language instructions;
said electronic network (150) coupling said at least one remote computer (110) with said multi-dimensional robotic web browser (120, 122); and
said multi-dimensional robotic web browser (120, 122), comprising:
means for receiving (125) said high level language instructions downloaded over said electronic network (150); and
means for rendering said downloaded high level language instructions, such that when at least a portion of said instructions are rendered by said robotic web browser (120, 122), direct said robotic web browser (120, 122) to one of move in three-dimensions, playback an audio stream, playback a video stream;

10. The system of claim 9, wherein said multi-dimensional robotic web browser (120, 122) further comprises:
means for storing said high level language instructions; and
means for retrieving said high level language instructions from said storing means, such that when at least a portion of said stored instructions are rendered by said robotic web browser (120, 122), direct said robotic web browser (120, 122) to one of move in three-dimensions, playback an audio stream, playback a video stream;

11. The system of claim 9, wherein said electronic network (150) is the Internet.

12. The system of claim 9, wherein said electronic network (150) is one of a wired or wireless network.
